(19) United States
(12) Patent Application Publication
(10) Pub. No.: US 2010/0036811 A1
(43) Pub. Date: Feb. 11, 2010

(54) SYSTEMS AND METHODS FOR MOBILE HEALTHCARE INFORMATION COLLECTION

(75) Inventors: Ashish Dolatrai Vassa, Palatine, IL (US); Mohammed Wahab, Carol Stream, IL (US); Mohan Naidu, Bartlett, IL (US)

Correspondence Address: HANLEY, FLIGHT & ZIMMERMAN, LLC, 150 S. WACKER DRIVE, SUITE 2100, CHICAGO, IL, 60606, US

(73) Assignee: GENERAL ELECTRIC COMPANY, Schenectady, NY (US)

(21) Appl. No.: 12/189,399

(22) Filed: Aug. 11, 2008

(51) Int. Cl. G06F 17/30

(52) U.S. Cl. 707/3; 707/E17.014

(57) ABSTRACT

Certain embodiments of the present invention provide methods and systems for mobile, location-based access to healthcare provider information. A mobile healthcare information system includes a healthcare provider module transmitting healthcare provider information within a certain range of the healthcare provider module, the provider information identifying a type and a location of a healthcare provider. The system also includes a user module providing access to available healthcare provider information within a certain range of a location of the user module. The user module receives the healthcare provider information for query and output to a user. The user module is a portable module providing location-based healthcare provider information to the user.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to collection of healthcare provider information. More particularly, the present invention relates to methods and systems to assist in automated collection and/or updating of healthcare provider information in a mobile environment.

Healthcare practice has become centered around electronic data and records management. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access and/or distribute patient information or other information at various points in a healthcare workflow.

Additionally, if a medical emergency occurs (e.g. a car accident, heart attack, stroke, broken bone, etc.), quick action can be important to save lives and reduce permanent injury. If an ill or injured person and/or others with that person cannot obtain up-to-date care information rapidly, the lack of information can cause problems for effective treatment of the individual and potentially endanger the individual and/or delay treatment.

Currently, healthcare provider contact information can be provided by storing the information in one's personal digital assistant (PDA) and/or phone, for example. Alternatively, a person can refer to the Yellow pages and/or some other directory look up. Additionally, one can retrieve information online using the Internet. Further, a global positioning system (GPS) may include stored information.

However, each of the above mentioned sources has limitations. For example, PDA/phone information can become outdated after sometime, if not updated regularly. Further, the information may not be relevant to providers outside of a user's typical geographic area. Yellow pages information can also become outdated, and it can be difficult to find a Yellow pages book around in case of an emergency. Similarly, an Internet connection may not be available everywhere. GPS information can also become outdated depending upon when the software was updated.

### BRIEF SUMMARY OF THE INVENTION

Certain embodiments of the present invention provide methods and systems for mobile, location-based access to healthcare provider information.

Certain embodiments provide a mobile healthcare information system. The system includes a mobile healthcare information device providing access to available provider information within a certain range. The provider information identifies a type and a location of a healthcare provider. The mobile healthcare information device including a receiver receiving the provider information for storage and output at the mobile healthcare information device, a memory storing the provider information, and an interface querying and outputting the provider information at the mobile healthcare information device.

Certain embodiments provide a method for providing updated healthcare provider information. The method includes receiving provider information for a healthcare provider at a mobile healthcare information device within a certain range of the healthcare provider. The provider information identifies a type and a location of the healthcare provider. The method also includes accepting a query regarding the provider information via the mobile healthcare information device. The method further includes displaying the provider information at the mobile healthcare information device in response to the query.

Certain embodiments provide a mobile healthcare information system. The system includes a healthcare provider module transmitting healthcare provider information within a certain range of the healthcare provider module, the provider information identifying a type and a location of a healthcare provider. The system also includes a user module providing access to available healthcare provider information within a certain range of a location of the user module. The user module receives the healthcare provider information for query and output to a user. The user module is a portable module providing location-based healthcare provider information to the user.

### BRIEF DESCRIPTION OF SEVERAL VIEWS OF THE DRAWINGS

FIG. 1 illustrates an example of a healthcare information communication system in accordance with an embodiment of the present invention.

FIG. 2 illustrates a flow diagram for a method for mobile collection of healthcare provider information according to an embodiment of the present invention,

FIG. 3 illustrates an example of a mobile healthcare information system in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide systems and methods to assist in automated collection and/or updating of healthcare provider information in a mobile or portable environment. For example, certain embodiments help enable collection and/or updating of healthcare provider information when a person is driving in an area.

Certain embodiments help obtain accurate contact information for nearby healthcare providers when a user is traveling or moving among different locations. Currently, information loaded into a personal digital assistant (PDA) or phone can get stale if not updated regularly. Global positioning system (GPS) information can also become stale or outdated depending upon when its software was updated. Yellow pages information can also become stale and is additionally often difficult to find in case of emergency. Further, an Internet connection may not be available to allow a Web-based electronic retrieval of information.

In certain embodiments, more up-to-date information may be provided wirelessly to a mobile device positioning within a certain distance of a transmitter. For example, suppose that Mr. John Doe is visiting San Diego with his family, and he has a mobile healthcare information receiver with him. The family does not otherwise have any information about nearby healthcare providers and their contact information. While the family is playing volleyball on the beach, Mr. Doe's son breaks his hand. In this case, it would be beneficial to have contact information for a nearby orthopedic clinic. Using the mobile device having a receiver, Mr. Doe can look up a nearby orthopedic clinic using information collected by the receiver while Mr. Doe was driving through the streets of San Diego. Healthcare providers, such as an orthopedic clinic, can continuously or periodic broadcast information within the area.

Certain embodiments provide location-specific information with improved accuracy available on demand via a user's receiver. Certain embodiments employ a push model rather than a pull model to dynamically obtain information regarding healthcare services in a given geographical area surrounding a receiving device. Certain embodiments provide transmitters that continuously and/or periodically broadcast and update information in area receiver(s) so that user(s) within a certain area have more current information.

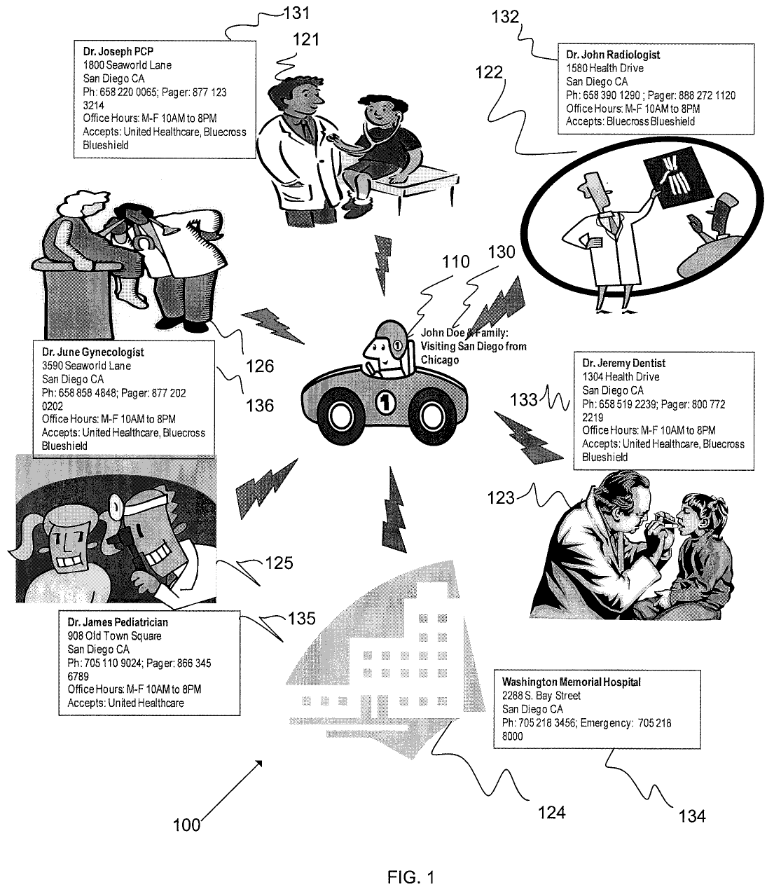

In certain embodiments, a communication system includes a receiver and a transmitter communicating with each other via a network and/or other communication protocol. The receiver can be an independent device or can be integrated with another electronic system, such as a GPS, phone/PDA, and/or automobile computer system. The transmitter can be a device installed at each interested healthcare service provider location as shown in FIG. 1. The transmitter can be programmed to continuously and/or periodically broadcast contact information for the healthcare provider. Hence, whenever a vehicle/person passes within a certain area and has a receiver, the transmitted information will be received and stored or updated in the receiver for use.

FIG. 1 illustrates an example of a healthcare information communication system 100 in accordance with an embodiment of the present invention. The system 100 includes a mobile healthcare information device 110 and a plurality of healthcare information transmitters 121-126. The plurality of healthcare information transmitters 121-126 provide contact information 131-136. In certain embodiments, the device 110 can provide information 130 as well. Information 130-136 can include provider name, provider address, provider phone number, provider facsimile number, provider pager number, provider office hours, provider insurance carrier information, etc. Information 130-136 can be transmitted from transmitters 121-126 using radio frequency transmission, cellular transmission, and/or other wireless communication, for example.

In certain embodiments, the mobile healthcare information device 110 and healthcare information transmitter(s) 121-126 can be implemented alone or in combination of hardware, software, and/or firmware. In certain embodiments, mobile healthcare information device 110 and/or healthcare information transmitter(s) 121-126 can include both transmitting and receiving hardware, software and/or firmware.

In certain embodiments, the device 110 includes a memory, a processor, and a receiver for receiving information from at least transmitters 121-126 within range. The device 110 may also include a transmitter to provide information about the user and/or device 110 location back to the healthcare provider 121-126. In certain embodiments, the memory can store user information, such as personal medical information and/or history, as well as information 131-136 received from provider(s) 121-126.

In certain embodiments, the device 110 allows information display and may also allow information entry and/or modification, for example. The device 110 includes a screen, such as an LCD or touchscreen, and may include an input device, such as a touchpad, touchscreen, keyboard, stylus, joystick, trackball, wheel, button, mouse and/or other input device. The device 110 may also include one or more speakers and/or microphones for audio output and/or input, for example. The device 110 may communicate with an external system via a wireless, wired, infrared, and/or other connection, for example.

In certain embodiments, some or all of the personal information stored on the device 110 may be read without authorization. In certain embodiments, no personal information stored on the device 110 may be read without authorization. The authorization may be made by, for example, the patient or a medical administrator Examples of personal information that may be accessed without authorization may include: patient name, address, patient contact information, and a patient identifier.

Patient information may include, for example, one or more of the following pieces of information: patient name, patient address, patient contact information, emergency contact information, insurance information, billing information, primary care doctor information, specialist information, drug information, allergy information, current medication information, and a patient identifier. Patient information may also include patient records and reports. In addition, patient information may also include, for example, biographical information, medical history, family history, genetic test results, blood test results, heart rate, blood pressure, blood flow, and biomarker presence information. The patient identifier may be unique, for example, within a network or globally. Blood test results may include, for example, test results for blood oxygen level, white blood cell count, T-cell count, complete blood count, thyroid, cardiac risk factors, cholesterol, proteins, PSA (prostate), waste products, and glucose. In certain embodiments, patient information may come from multiple sources. For example, patient information may come from one or more of the patient, an insurance company, an in-network healthcare provider, and an out-of-network healthcare provider.

In operation, a user with the device 110 is traveling in an area having a plurality of healthcare providers. The plurality of healthcare providers use healthcare information transmitters 121-126 to broadcast information 130-136 regarding their healthcare services within the geographic area. The device 110 receives the information 130-136 broadcasts when the device is in the area. If a situation for medical assistance or consultation arises, the user can refer to the device 110 for information 130-136 regarding providers in the area.

For example, if a user's child becomes sick on vacation, the user can refer to the device 110 and determine that, based on the information 135 from the transmitter 125, Dr. James Pediatrician is located nearby at a certain address with certain office hours and accepts certain insurance. In certain embodiments, the device 10 may initiate a communication, such as a phone call, to confirm availability and notify the provider of the user's impending arrival. In certain embodiments, the information 135 may include website information which the user can view via the device 110, for example.

As another example, if a user develops a toothache while traveling and wants the tooth checked for a cavity, the device 110 can be reviewed to identify contact information 133 for a dentist in the area.

The device 110 can be used to retrieve various other provider information including primary care physician information 131, radiologist information 132, hospital information 134, and gynecologist and/or other specialist information 136 broadcast from transmitters 121, 122, 124, 136 and received by the device 110 within a given radius or area of signal transmission.

Certain embodiments enable users to transfer at least certain medical history or and/or other personal medical information (PMI) from the device 110 to a retrieval device at a provider site. Transfer of personal medical information can save time, improve user experience, and improve accuracy of information, for example.

In an emergency scenario, certain embodiments can be used to retrieve all or part of a patient medical history from the device 110 and transfer the information into a scanning device at the provider to provide an emergency medical technician, clinician, and/or other hospital staff/system with the information. In certain embodiments, security measures, such as password and/or biometric authentication, can be built into the phone and/or retrieval device to help ensure that the individual's information was not transmitted inappropriately.

In certain embodiments, the device 110 uses a configurable retention algorithm to determine which information 131-136 is stored in memory and for how long the information is stored. In certain embodiments, grace periods can be configured to eliminate repeated loading and purging of information 131-136 from providers on an edge of an area range.

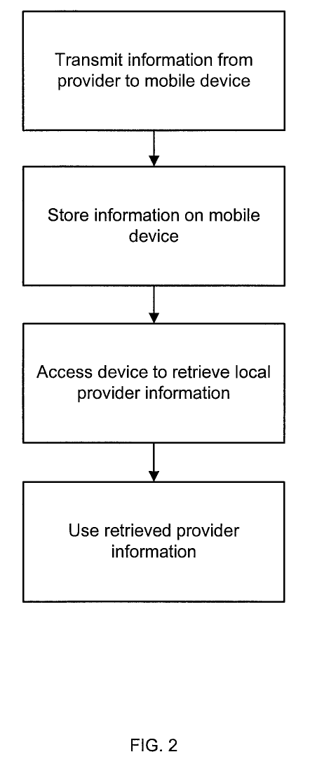

FIG. 2 illustrates a flow diagram for a method 200 for mobile/portable collection of healthcare provider information according to an embodiment of the present invention. At 210, information is transmitted from a healthcare provider to a mobile healthcare device within range of the provider. At 220, the information is stored on the mobile healthcare device. At 230, the device is accessed to retrieve local provider information. At 240, retrieved provider information is used to contact and/or direct the user to a healthcare provider.

Referring back to FIG. 2 in more detail, at 210, information is transmitted from a healthcare provider to a mobile healthcare device within range of the provider. For example, a healthcare provider can include a transmitter (and possibly receiver) device, such as radios, computers, wireless local area networks, etc., to facilitate wireless transmission of information regarding that provider and services offered by that provider. For example, a primary care physician can advertise that he or she is a primary care physician and include office location, directions, office hours, insurance information, services offered, etc. A mobile healthcare device within a certain range of the transmitter receives this information. In certain embodiments, any such device within range can receive and understand the information. In certain embodiments, only registered or otherwise authorized devices can receive and process the information.

At 220, the information is stored on the mobile healthcare device. For example, a mobile healthcare device within a certain range of the transmitted information receives the information and stores the information temporarily or more permanently in a memory and/or other storage on the mobile healthcare device.

At 230, the device is accessed to retrieve local provider information. For example, a user may interact with the device via touchscreen, keypad, scroll and/or clickwheel, voice command, etc., to retrieve information about local provider(s) within a certain range of the device. Information may be retrieved based on all provider(s) in the area and/or by provider(s) of a particular type in the area, for example. Provider information may be displayed on a screen with the device and/or may otherwise be output, such as via an audible response, for example.

At 240, retrieved provider information is used to contact and/or direct the user to a healthcare provider. For example, a user may touch a spot on the screen, press a button, use a voice command, etc., to initiate a call with a provider, send a message to a provider, access a provider website and/or other information portal, etc. As an example, selecting a local pediatrician allows the user to initiate a phone call to that pediatrician via the device and/or a phone/radio in communication with the device (e.g., via WiFi, Bluetooth, and/or other wired or wireless communication protocol).

In certain embodiments, the user can then exchange further information with the provider via the device.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a farther example, certain steps may be performed in a different temporal order, including simultaneously, than listed above.

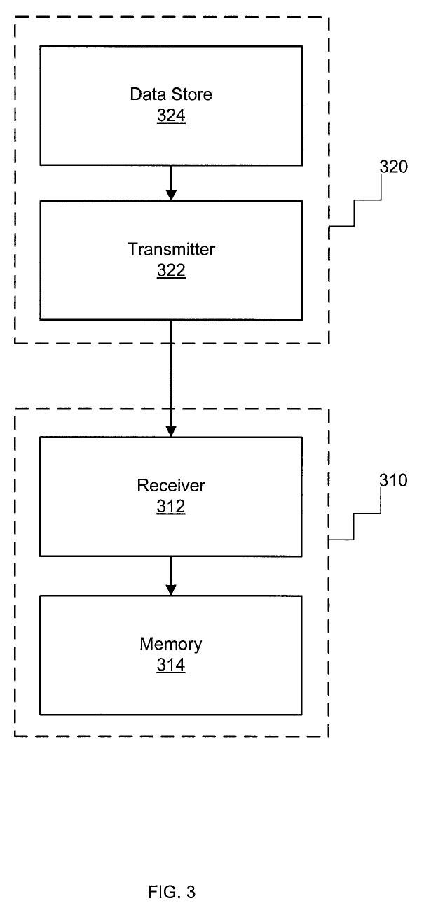

FIG. 3 illustrates an example of a mobile healthcare information system 300 in accordance with an embodiment of the present invention. The system 300 can be used to implement the examples described above with respect to FIGS. 1 and 2, for example, as well as other embodiments falling within the scope of the present invention. The system 300 includes a user module 310 and a healthcare provider module 320. The user module 310 communicates with the healthcare provider module 320 to receive information from the healthcare provider module 320. The user module 310 may also transmit information back to the healthcare provider module 320, but in some cases the transmission of information may be one-way, from the module 320 to the module 310.

Information communicated between the user module 310 and the healthcare provider module 320 can include provider name, provider address, provider phone number, provider facsimile number, provider pager number, provider office hours, provider insurance carrier information, etc. Information can also include user name, user location, user medical history, etc. Information can be transmitted using radio frequency transmission, cellular transmission, and/or other wireless communication, for example. In certain embodiments, data security, such as encryption, password protection, biometric authentication, and the like, can be used to protect some or all of the information being transmitted.

The user module 310 may, for example, include a receiver 312 and a memory 314. The receiver 312 may optionally include transmitter functionality to provide information back to the provider module 320. The receiver 312 may include a processor and/or a processor (not shown) may be provided in the user module 310 in addition to the receiver 312 and memory 314. The memory 314 may store data such as information received from the provider module 320, user information, instructions/code for execution, etc.

The healthcare provider module 320 may, for example, include a transmitter 322 and a database or other storage 324. The transmitter 322 may optionally include receiver functionality to receive information for the user module 310. The transmitter 322 may include a processor and/or a processor (not shown) may be provided in the healthcare provider module 320 in addition to the transmitter 322 and data store 324. The data store 324 may store data such as provider information, patient medical record information, scheduling information, instructions/code for execution, etc.

In certain embodiments, the healthcare provider module 320 transmits provider information which is received by the user module 310 when the module 310 is within range of the module 320. In certain embodiments, the healthcare provider module 320 may receive a response from the user module 310 when the user module 310 is within range and has received the provider information.

In certain embodiments, the user module 310 allows information display and may also allow information entry and/or modification, for example. For example, the user module 310 can include a screen, such as an LCD or touchscreen, and can include an input device, such as a touchpad, touchscreen, keyboard, stylus, joystick, trackball, wheel, button, mouse and/or other input device. The user module 310 may also include one or more speakers and/or microphones for audio output and/or input, for example. The user module 310 can communicate with the healthcare provider module 320 via a wireless, wired, infrared, and/or other connection, for example. In certain embodiments, the user module 310 can be incorporated into a cellular phone, personal digital assistant, handheld computer, laptop computer, radio, navigation system, other automobile computer system, etc.

In certain embodiments, the healthcare provider module 320 can be connected to a workstation to allow display, retrieval, and manipulation of data stored in the data store 324. For example, the module 320 can be connected to a monitor and keyboard to allow provider information to be updated, schedules to be maintained, patient information to be reviewed, etc. For example, the module 320 can be incorporated in a healthcare information system, such as a PACS, RIS, EMR, etc.

In certain embodiments, the user module 310 and the healthcare provider module 320 can be implemented using hardware, software, and/or firmware. In certain embodiments, the user module 310 can pull information from the provider module 320. In certain embodiments, the provider module 320 can push information to the user module 310.

Thus, certain embodiments provide a technical effect of providing more accurate information regarding local healthcare providers to a potential patient via a mobile healthcare information device. Certain embodiments provide a mobile framework for exchange of healthcare information between providers and customers. Certain embodiments provide location-specific provider information with improved accuracy on-demand for a user.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or dedicated processors.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection(either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of a variety of healthcare information systems. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A mobile healthcare information system, the system comprising:
a mobile healthcare information device providing access to available provider information within a certain range, said provider information identifying a type and a location of a healthcare provider, said mobile healthcare information device comprising:
a receiver receiving said provider information for storage and output at said mobile healthcare information device;
a memory storing said provider information; and
an interface querying and outputting said provider information at said mobile healthcare information device.

2. The system of claim 1, further comprising a healthcare provider information transmitter transmitting said provider information within a certain range.

3. The system of claim 2, wherein said mobile healthcare information device further comprises a transmitter transmitting information to said healthcare provider information transmitter.

4. The system of claim 2, wherein said mobile healthcare information device pulls said provider information from said healthcare provider information transmitter.

5. The system of claim 2, wherein said healthcare provider information transmitter pushes said provider information to said mobile healthcare information device.

6. The system of claim 1, wherein said provider information further comprises at least one of provider contact information and provider insurance carrier information.

7. The system of claim 1, wherein said mobile healthcare information device directs a user to said location of said healthcare provider using said provider information.

8. The system of claim 1, wherein said mobile healthcare information device is integrated with a telephone.

9. The system of claim 1, wherein said mobile healthcare information device is integrated with an automobile computer system.

10. A method for providing updated healthcare provider information, said method comprising:
receiving provider information for a healthcare provider at a mobile healthcare information device within a certain range of said healthcare provider, said provider information identifying a type and a location of said healthcare provider;
accepting a query regarding said provider information via said mobile healthcare information device; and
displaying said provider information at said mobile healthcare information device in response to said query.

11. The method of claim 10, further comprising storing said provider information at said mobile healthcare information device.

12. The method of claim 10, further comprising transmitting information from 10 said mobile healthcare information device to said healthcare provider in response to said provider information.

13. The method of claim 10, wherein said provider information further comprises at least one of provider contact information and provider insurance carrier information.

14. The method of claim 10, further comprising directing a user to said location of said healthcare provider using said provider information via said mobile healthcare information device.

15. The method of claim 10, wherein said mobile healthcare information device pulls said provider information from said healthcare.

16. The system of claim 2, wherein said healthcare provider pushes said provider information to said mobile healthcare information device.

17. A mobile healthcare information system, the system comprising:
a healthcare provider module transmitting healthcare provider information within a certain range of said healthcare provider module, said provider information identifying a type and a location of a healthcare provider; and
a user module providing access to available healthcare provider information within a certain range of a location of said user module, said user module receiving said healthcare provider information for query and output to a user, said user module comprising a portable module providing location-based healthcare provider information to said user.

18. The system of claim 17, wherein said healthcare provider module transmits said healthcare provider information wirelessly.

19. The system of claim 17, wherein said user module provides directions to said user regarding said location of said healthcare provider using said healthcare provider information.

20. The system of claim 17, wherein said user module is integrated with at least one of a telephone and an automobile computer system.
